(19) United States
(12) Patent Application Publication
(10) Pub. No.: US 2007/0257504 A1
(43) Pub. Date: Nov. 8, 2007

(54) Windshield covering for cold weather

(76) Inventor: Manuel Aguilar, Guadalupe, CA (US)

Correspondence Address: LAW OFFICES OF ANDREW Y. SCHROEDER, 500 SOUTH BROADWAY, SUITE 222, SANTA MARIA, CA, 93454, US

(21) Appl. No.: 11/430,422

(22) Filed: May 8, 2006

(51) Int. Cl. B60J 3/00

(52) U.S. Cl. 296/97.7

(57) ABSTRACT

An apparatus for covering a windshield of an automobile and affixing the apparatus to the windshield by fastening with the side view mirror comprising: a panel and a fastener, the panel comprising a substantially planar member with a bottom side and a top side, a left edge and a right edge, the bottom side facing the windshield and the top side facing away from the windshield, the panel having a size to cover most or all of the surface area of a windshield, the panel further comprising at least two holes, a first hole located near the left edge and a second hole located near the right edge; the fasteners affixed to the panel; the fasteners having a length to wrap around the side view mirror thereby affixing the apparatus with the automobile.

### FIELD OF THE INVENTION

The present invention relates with automobile accessories and more particularly relates with automobile windshield coverings.

### BACKGROUND OF THE INVENTION

During winter months many people who wake up in the morning are confronted with an annoying problem. As they are hurrying out of their homes and rushing their way to work they find ice and snow on their windshields. This ice is oftentimes very thick, hard and impossible to remove with windshield wipers. Furthermore, this ice and snow will take up to an hour or longer to melt once the car is turned on and the windshield vents are turned on full tilt. Even when one uses a squeegee type scraping apparatus the ice can be so thick it may take a person several minutes to scrape away all the ice from the windows.

Although some people who are confronted with ice in the morning choose to drive without scraping they pose a serious danger to others on the road. Any type of ice whether it is thick, thin, or transparent will seriously obstruct the view of a driver. This ice eclipses a driver's sight and creates blind spots for a driver. Although sometimes the ice might melt in a matter of minutes, it might take less time for that driver to seriously collide with someone and injure him or herself as well as others.

The current marketplace has not adequately taken care of this serious problem. First of all, most automobiles only have heating vents which heat the windshield from the inside. Unfortunately, the ice is on the outside and it may take several minutes in order for the heat to transfer through the thickness of the windshield. Furthermore, even the most powerful automobile heaters will take at least 10 minutes in order for the outside ice to completely melt.

Squeegee-type tools with a scraper side are not much better. Many of these tools are not sharp enough to cut through thick ice. In addition, the inherent curvature of most automobile windshields is such that the scraper cannot take a good angle for scraping the ice and often the scraper will veer off from the interfacing contact with the windshield and onto the top of the ice. Furthermore, the squeegee tools are little use when there is thick ice upon the windshield and there is no exposed windshield surface to gain a toehold in order to start scraping. In this situation, one must first cut through the ice in order to interface contact with the windshield. Afterwards, one may be able to leverage the windshield with the ice in order to scrape them off.

Some people attempt to remove ice with water. Unfortunately, depending upon the ambient temperature and wind chill factor it may take several buckets full of cold water in order to completely remove ice from a windshield. Furthermore, this is problematic because as someone is getting ready to head off for work oftentimes this water will splash and slosh about and soaking the person. In cold weather this can be quite annoying.

Moreover, some people try to remove the ice with warm or hot water. Although this does speed up the process this poses a risk to the windshield. Too much warm water may force the windshield to crack or break due to the extreme tension between the ambient temperature with the warmer temperature on the inside surface of the windshield. Furthermore, as with cold water, the person can still get soaked with water.

Therefore, what is clearly needed in the marketplace is an apparatus for preventing ice formation upon an automobile windshield. Such an apparatus should be quick, easy to use, economical, and easy to stow away in a car.

### SUMMARY OF THE INVENTION

It is an object of the present invention to provide an apparatus for the prevention of ice formation upon the surface of automobile windshields. The present invention comprises an apparatus for covering a windshield of an automobile and affixing the apparatus to the windshield by fastening with the side view mirror comprising:

a panel and a fastener, the panel comprising a substantially planar member with a bottom side and a top side, a left edge and a right edge, the bottom side facing the windshield and the top side facing away from the windshield, the panel having a size to cover most or all of the surface area of a windshield, the panel further comprising at least two holes, a first hole located near the left edge and a second hole located near the right edge; the fasteners affixed to the panel; the fasteners having a length to wrap around the side view mirror thereby affixing the apparatus with the automobile.

### BRIEF DESCRIPTION OF THE DRAWING FIGURES

FIG. 1 is a perspective view of a preferred embodiment of the present invention.

FIG. 2 is a perspective view of a preferred embodiment of the present invention.

FIG. 3 is a perspective view of a preferred embodiment of the present invention.

FIG. 4a is a perspective view of a preferred embodiment of the present invention.

FIG. 4b is a perspective view of a preferred embodiment of the present invention.

FIG. 5a is an isometric view of a preferred embodiment of the present invention.

FIG. 5b is an isometric view of a preferred embodiment of the present invention.

FIG. 6 is a perspective view of a preferred embodiment of the present invention.

### DESCRIPTION OF PREFERRED EMBODIMENTS

According to a preferred embodiment of the present invention, a unique apparatus is used to cover automobile windshields in order to prevent ice from forming upon the surface of the windshield. By preventing the formation of ice on a windshield, a person will not have to scrape or otherwise remove the ice from the windshield by laborious means. With the present invention a user will simply remove the apparatus and place it in his or her car. Since the apparatus was covering the windshield overnight or even during the day, no ice will form upon the surface of the windshield. The present invention is described in enabling detail below.

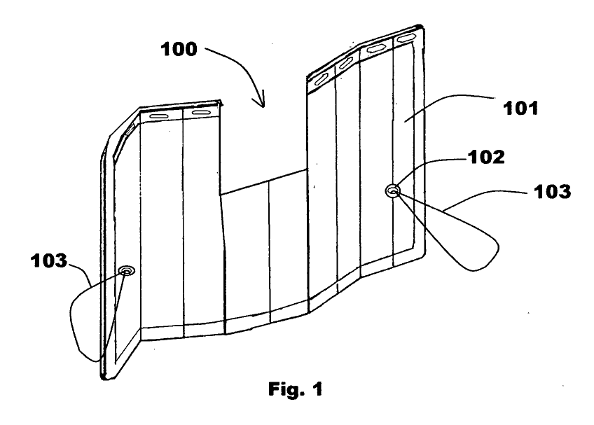

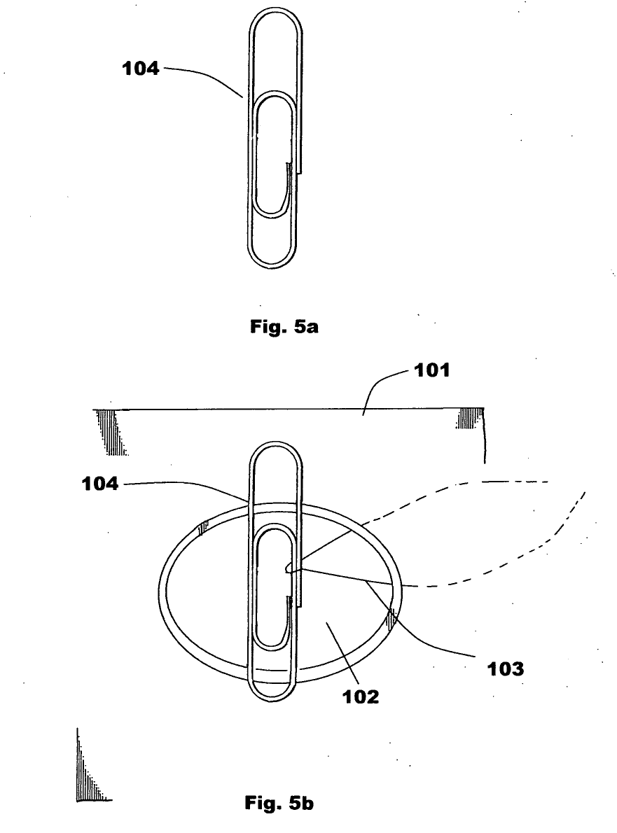

FIG. 1 illustrates one preferred embodiment of the present invention. Windshield covering apparatus 100 (hereafter referred to as WCA 100) comprises an accordion-style panel (hereafter panel 101), holes 102, rubber fasteners 103, and anchor 104 (shown in FIGS. 5a and 5b).

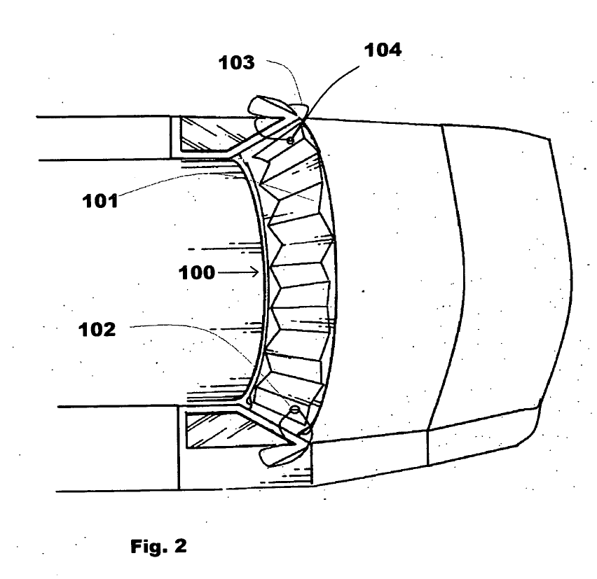

FIG. 2 illustrates how the WCA 100 is placed upon the windshield. First the panel 101 is unfolded and stretched out such that it covers the surface of the windshield. Then the rubber fasteners 103 are wrapped around the side mirrors of the automobile.

In this preferred embodiment the panel 101 is comprised of cardboard. Cardboard is an expedient material because it is lightweight, economical, durable, pliable for folding, and easy to use. Although cardboard is mentioned here as a preferred material other equally expedient materials abound which may also comprise the panel 100. Examples include, aluminum, plastic, polyethylene or other synthetic materials, rubber, wood, etc. For this reason, the type of material used is immaterial and should not be construed as limiting to the present invention.

Moreover, in preferred embodiments which use cardboard panels a layer of shellac is added to the outside surface to make the panel sturdier and impervious to water. Other materials may also be used to coat the outside surface in order to make the outside surface water-resistant.

Rubber fasteners 103 are comprised of long rubber bands. Rubber bands are expedient for the present invention due to their elasticity, durability, and ease in which a user can simply wrap around the side view mirror and firmly affix thereto. Elasticity is important because it ensures a tight fit between the panel and the side view mirror. Without a tight fit, the panel may fall off or simply get blown off by a strong gust of wind in a storm.

Although in this preferred embodiment rubber bands are used, other fungible means may also be used. It is conceivable that the rubber fasteners 103 may be replaced with pre-measured strings, cords, or wires which will fasten the panel to the windshield.

In other preferred embodiments the rubber fasteners 103 may be replaced with Velcro-type fasteners which will be called VF's. Windshield fastener will be affixed with panel on one end and on the other end be comprised with either loops or hooks material which will mate with hoops or loops material on the car. The mating material may be placed discretely by an adhesive patch with the loops or hooks material on the underside of the tire well. Or it may be placed discretely underneath the side view mirror.

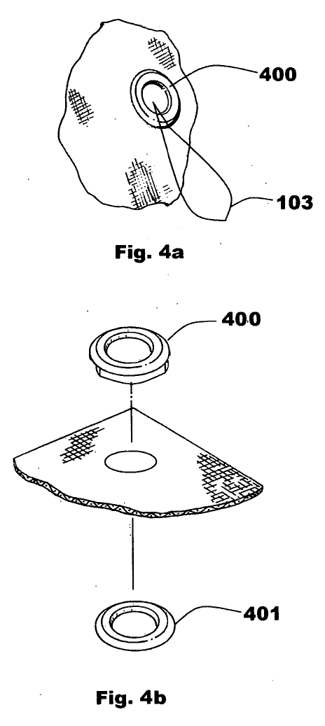

FIGS. 4a-b and 5a-b illustrate the holes 102 and the anchor 104. Holes 102 are made into the panel 101 in order to affix the rubber fasteners to it. Anchor 104 is used in order to secure the rubber fastener 103. Anchor 104 may be a paper clip sized to be larger than the diameter of the hole. Many different types of anchors 104 may be used. In short, anchor 104 may comprise any sort of shape, size, configuration which will not be able to be pulled through the hole 102 to the other side in which the rubber fastener 103 is pulling from.

In other preferred embodiments, the rubber fasteners 103 are simply tied through the hole 102 and fastened as a knot. In this particular embodiment, an anchor is not used. And in yet other embodiments, the panel 101 does not have holes 102 or anchors. The rubber fasteners are affixed to the panel via other means such as Velcro, glue, or other means.

In addition, the holes 102 are further strengthened through use of mating supports 400 and 401. Top mating support 400 is sized to mate with and snap together with bottom mating support 401. This is illustrated in FIGS. 4a-4b. Although mating supports are used in this preferred embodiment, other means abound which may also strengthen the holes 102. For this reason, the specific type of mating supports are not to be construed as limiting to the present invention.

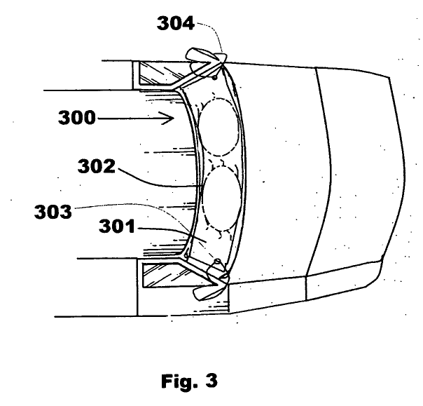

FIG. 3 illustrates another preferred embodiment of the present invention. Hoop cover apparatus (hereafter HCA 300) comprises a windshield HCA 300 with hoop skeleton 302 (hereafter hoop covering 301), holes 303, anchor, and rubber fasteners 304. The only difference in this particular embodiment is that the covering is comprised of a pliable hoop skeleton which easily folds such that it stores away easily in a person's automobile. There are usually two hoops which forms this skeleton: one for the left side of the windshield and one for the right side of the windshield. Furthermore, as with the panel embodiment, HCA 300 the rubber fasteners 304 may be secured with the hole 303 via knots or other similar means.

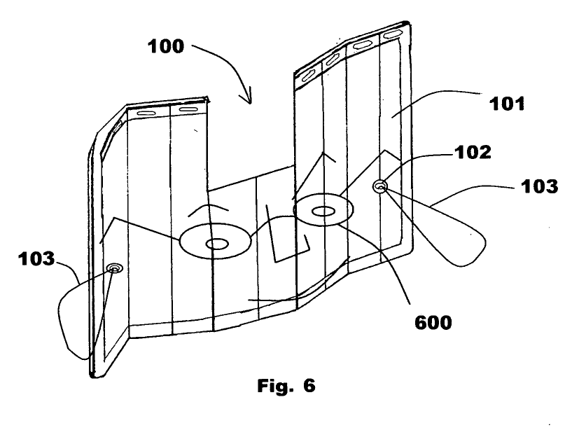

FIG. 6 illustrates another embodiment of the present invention which further incorporates designs or other indicia 600. In some preferred embodiments, the panel may further incorporate indicia 600. Indicia may include marketing information, designs, trademarks, paintings and other artistic work. The possibilities are endless.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. An apparatus for covering a windshield of an automobile and affixing the apparatus to the windshield by fastening with the side view mirror comprising:
a panel and a fastener, the panel comprising a substantially planar member with a bottom side and a top side, a left edge and a right edge, the bottom side facing the windshield and the top side facing away from the windshield, the panel having a size to cover most or all of the surface area of a windshield, the panel further comprising at least two holes, a first hole located near the left edge and a second hole located near the right edge; the fasteners affixed to the panel; the fasteners having a length to wrap around the side view mirror thereby affixing the apparatus with the automobile.

2. The apparatus of claim one further comprising holes in the panel; the holes for use in affixing the fasteners with the panel.

3. The apparatus of claim two further comprising an anchor, the anchor being affixed with a distal end of the fastener.

4. The apparatus of claim one wherein the panel is foldable or collapsible.

5. The apparatus of claim one wherein the panel is composed of cardboard.

6. The apparatus of claim one wherein the panel further comprises a hoops skeleton.

7. The apparatus of claim one further comprising hole supports, the hole supports are used for the purpose of strengthening the holes.

8. The apparatus of claim seven wherein the hole supports are composed of metal.

9. The apparatus of claim one wherein the fastener is composed of rubber.

10. The apparatus of claim nine wherein the fastener is a rubber band.

11. The apparatus of claim one wherein the panel further comprises indicia printed thereon.

12. The apparatus of claim 11 wherein the indicia is a cartoon or other design.

13. The apparatus of claim one further comprising a layer of shellac coating the outside surface of the panel.

14. The apparatus of claim one further comprising an anchor, the anchor is placed the top side, the anchor is affixed with the fastener.

15. The apparatus of claim 14 wherein the anchor is a paper clip.

16. An apparatus for covering a windshield of an automobile and affixing the apparatus to the windshield by fastening with the side view mirror comprising:
a panel and at least two elastic fasteners, the panel comprising a substantially planar member with a bottom side and a top side, a left edge and a right edge, the bottom side facing the windshield and the top side facing away from the windshield, the panel having a size to cover most or all of the surface area of a windshield, the panel further comprising at least two holes, a first hole located near the left edge and a second hole located near the right edge; the elastic fasteners affixed to the panel; the elastic fasteners having a length to wrap around the side view mirror thereby affixing the apparatus with the automobile.

17. The apparatus of claim 16 wherein the elastic fastener is a rubber band.

18. The apparatus of claim 17 further comprising an anchor.

19. The apparatus of claim 18 further comprising hole supports.

20. An apparatus for covering a windshield of an automobile and affixing the apparatus to the windshield by fastening with the side view mirror comprising:
a collapsible panel, an anchor, hole supports and at least two elastic fasteners, the panel comprising a substantially planar member with a bottom side and a top side, a left edge and a right edge, the bottom side facing the windshield and the top side facing away from the windshield, the panel having a size to cover most or all of the surface area of a windshield, the panel further comprising at least two holes, a first hole located near the left edge and a second hole located near the right edge, the panel further comprising a layer of water-resistant material; the elastic fasteners affixed to the panel; the elastic fasteners having a length to wrap around the side view mirror thereby affixing the apparatus with the automobile.
